(19) United States
(12) Patent Application Publication
(10) Pub. No.: US 2007/0209465 A1
(43) Pub. Date: Sep. 13, 2007

(54) Screw Device And Method Of Manufacturing The Same

(75) Inventors: Takeki Shirai, Tokyo (JP); Yuji Tachikake, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Tokyo (JP)

(21) Appl. No.: 11/547,804

(22) PCT Filed: Apr. 8, 2005
(86) PCT No.: PCT/JP05/06945

§ 371 Date: Oct. 6, 2006

(30) Foreign Application Priority Data
Apr. 8, 2004 (JP) 2004-114474

(51) Int. Cl. F16H 25/22

(52) U.S. Cl. 74/424.71

(57) ABSTRACT

A screw device is provided with a screw shaft 5 formed, on an outer peripheral surface thereof, with a ball member rolling groove 6 in form of spiral, a nut 1 formed, on an inner peripheral surface thereof, with at least single one-turn of groove 4 constituted by a loaded ball rolling groove 2 having a partial circle less than one circle of groove and corresponding to the ball rolling groove 6 of the screw shaft and a ball circulation groove 3 connecting one and other ends of the loaded ball rolling grove 2, and a plurality of balls arranged and accommodated between the ball rolling groove 6 of the screw shaft 5 and the loaded ball rolling groove 2 and the ball circulation groove 3 of the nut 1. The loaded ball rolling groove 2 and the ball circulation groove 3 of the nut 1 are formed by cutting the inner peripheral surface of the nut which was preliminarily heat-treated. According to the screw device thus formed, the positional relationship between the loaded ball rolling groove and the ball circulation groove can be precisely set.

### TECHNICAL FIELD

The present invention relates to a screw device in which a rolling member is interposed to be rotatable between a screw shaft and a nut.

### BACKGROUND TECHNOLOGY

There is known a ball screw in which balls are disposed to be movable between the screw shaft and the nut member. When the screw shaft is rotated relatively to the nut, a plurality of balls interposed between a ball rolling groove of the screw shaft and a loaded ball rolling groove of the nut roll and move, and the nut is moved in an axial direction of the screw shaft. The use of the ball screw can reduce frictional resistance at a time of rotating the screw shaft with respect to the nut.

In a tendency that an electrically driven power steering device is generalized, it is required to reduce thickness of the nut and simplify a circulation structure, and in the current tendency, deflector-type ball screw has taken main stream. In the deflector-type ball screw, deflector (which may be called “piece”) is embedded to circulate the balls in the nut. The deflector is formed with a ball circulation groove to be connected to a loaded ball circulation groove of the nut. The ball circulation groove of the deflector serves to return the ball rolling on a spiral ball rolling groove around the screw shaft by get over a screw thread of the screw shaft before one turn of groove.

In order to smoothly circulate the ball, it is important to precisely manufacture a portion connecting the loaded ball rolling groove of the nut and the ball circulation groove of the deflector. However, in the conventional deflector-type ball screw, a deflector is embedded in a hole formed to the nut and, thereafter, the deflector is fixed to the nut by means of binding, so that the deflector is easily shifted in its position in the axial and radial direction of the nut, and hence, it was difficult to precisely manufacture that portion connecting the loaded ball rolling groove of the nut and the ball circulation groove of the deflector.

In order to solve such problem as mentioned above of the deflector-type ball screw, there is provided a ball screw in which the loaded ball rolling groove and the ball circulation groove are integrally formed to the nut without incorporating the deflector as independent member to the nut (see Patent Publication 1).

Patent Publication 1: Japanese Patent Laid-open Publication No. 2003-307263

### DISCLOSURE OF THE INVENTION

Problems to be Solved by The Invention

When the nut is quenched in order to increase the strength of the nut, a distortion is caused by heat (thermal) treatment to the loaded ball rolling groove and the ball circulation groove of the nut even in a cylindrical nut. This distortion may disturb smooth circulation of the ball in a region at which the loaded ball rolling groove is connected to the ball circulation groove.

Then, an object of the present invention is to provide a screw device capable of precisely setting a positional relationship between a loaded ball rolling groove and a ball circulation groove both formed to the nut and also provide applied examples of such screw device.

Means for Solving the Problem

Hereunder, the present invention will be described. Further, in order to easy understanding of the present invention, reference numerals in the drawings are added with parentheses, but the present invention is not limited thereby to embodiments shown in the drawings.

In order to solve the above problem, the invention of claim 1 is a screw device comprising: a screw shaft (5) formed, on an outer peripheral surface thereof, with a rolling member rolling groove (6) in form of spiral; a nut (1) formed, on an inner peripheral surface thereof, with at least single one-turn of groove (4) constituted by a loaded rolling member rolling groove (2) having a partial circle less than one circle of groove and corresponding to the rolling member rolling groove (6) of the screw shaft (5) and a rolling member circulation groove (3) connecting one and another ends of the loaded rolling member rolling groove (2); and a plurality of rolling members arranged and accommodated between the rolling member rolling groove (6) of the screw shaft (5) and the loaded rolling member rolling groove (2) and the rolling member circulation groove (3) of the nut (1), wherein the loaded rolling member rolling groove (2) and the rolling member circulation groove (3) of the nut (1) are formed in the inner peripheral surface, which is preliminary heat-treated, by performing a cutting working.

The invention of claim 2 is characterized, in the screw device in claim 1, in that only the loaded rolling member rolling groove (2) of the nut (1) is ground after the cutting working, and the rolling member circulation groove (3) of the nut (1) is not subjected to the cutting working.

The invention of claim 3 is a screw device comprising: a screw shaft (5) formed, on an outer peripheral surface thereof, with a rolling member rolling groove (6) in form of spiral; a nut (1) formed, on an inner peripheral surface thereof, with a plurality of rings (21) each formed from at least single one-turn groove (4) constituted by a loaded rolling member rolling groove (2) having a partial circle less than one circle of groove and corresponding to the rolling member rolling groove (6) of the screw shaft (5) and a rolling member circulation groove (3) connecting one and another ends of the loaded rolling member rolling groove (2); and a plurality of rolling members arranged and accommodated between the rolling member rolling groove (6) of the screw shaft (5) and the loaded rolling member rolling groove (2) and the rolling member circulation groove (3) of the ring (21).

The invention of claim 4 is a screw device comprising: a screw shaft (5) formed, on an outer peripheral surface thereof, with a rolling member rolling groove (6) in form of spiral; a nut (1) formed, on an inner peripheral surface thereof, with at least single one-turn (4) of groove constituted by a loaded rolling member rolling groove (2) having a partial circle less than one circle of groove and corresponding to the rolling member rolling groove (6) of the screw shaft (5) and a rolling member circulation groove (3) connecting one and another ends of the loaded rolling member rolling groove (2); and a plurality of rolling members arranged and accommodated between the rolling member rolling groove (6) of the screw shaft (5) and the loaded rolling member rolling groove (2) and the rolling member circulation groove (3) of the nut (1), wherein a crowning (19) is formed at a connecting portion of the loaded rolling member rolling groove (2) to the rolling member circulation groove (3) so that a gap between the rolling member rolling groove (6) of the screw shaft (5) and the loaded rolling member rolling groove (2) is gradually widened toward the rolling member circulation groove (3).

The invention of claim 5 is a screw device comprising: a screw shaft (5) formed, on an outer peripheral surface thereof, with a rolling member rolling groove (6) in form of spiral; a nut (22) formed, on an inner peripheral surface thereof, with at least single one-turn of groove constituted by a loaded rolling member rolling groove (25) having a partial circle less than one circle of groove and corresponding to the rolling member rolling groove (6) of the screw shaft (5) and a rolling member circulation groove (24) connecting one and another ends of the loaded rolling member rolling groove (25); and a plurality of rolling members arranged and accommodated between the rolling member rolling groove (6) of the screw shaft (5) and the loaded rolling member rolling groove (25) and the rolling member circulation groove (24) of the nut (22), wherein a foreign material (26) different in substance from that of the nut (22) is fitted to the rolling member circulation groove (24) of the nut (22), and the loaded rolling member rolling groove (25) of the nut (22) and the rolling member circulation groove (24) of the foreign material (26) are formed by preliminarily cutting the nut (22) to which the foreign material (26) is fitted.

The invention of claim 6 is a method of manufacturing a screw device in which a rolling member is interposed between a screw shaft (5) and a nut (1), wherein the nut (1) is heat-treated and, thereafter, at least single one-turn of groove constituted by a loaded rolling member rolling groove (2) having a partial circle less than one circle of groove and corresponding to the rolling member rolling groove (5) of the screw shaft (6) and a rolling member circulation groove (3) connecting one and another ends of the loaded rolling member rolling groove (2) is formed, by a cutting working, to an inner peripheral surface of the nut (1).

The invention of claim 7 is characterized, in the screw device manufacturing method of claim 6, in that one-turn of groove is subjected to cutting working by imparting a rotational cutting main motion to a cutting tool (13) disposed inside the nut (1) and imparting a feeding motion to at least one of the nut (1) and the cutting tool (13).

### EFFECT OF THE INVENTION

According to the invention of claim 1, since the loaded rolling member rolling groove and the rolling member circulation groove are formed to the inner peripheral surface of the nut after the heat-treatment to the nut, any distortion is not caused to these grooves due to the heat-treatment. Accordingly, the loaded rolling member rolling groove and the rolling member circulation groove of the nut can be precisely manufactured.

According to the invention of claim 2, the loaded rolling member rolling groove on which the loaded rolling member rolls with the load being applied can be finished further finely. On the other hand, with the rolling member circulation groove, the rolling member does not roll with any load, and the rolling member circulation groove has itself a complicated groove shape, so that it is desired for the rolling member circulation groove is not to be subjected to any grinding working.

According to the invention of claim 3, since a plurality of rings, each being formed with the loaded rolling member rolling groove and the rolling member circulation groove, are assembled in the axial direction of the screw shaft so as to constitute a nut, a nut strong in the moment load can be provided. In addition, the rings can be sold as a standardized product such as bearing.

According to the invention of claim 4, in the case when the rolling member advances in a meandering manner into the rolling member circulation groove, resistance in the advancing direction of the rolling member can be reduced.

According to the invention of claim 5, by assembling the nut with a foreign material, attenuation effect, lubricating effect, noise-absorbing effect or vibration damping effect can be applied.

Furthermore, the invention of the screw device of claim 1 can be constituted as an invention of a manufacturing method such as the invention of claim 6.

In the invention of claim 7, by applying the rotational cutting main motion to a cutting tool disposed inside the nut and giving the feeding motion to at least one of the nut and the cutting tool, one-turn of groove can be formed to the inner peripheral surface of the nut.

### BRIEF DESCRIPTION OF THE DRAWINGS

FIG. 1 is a perspective view showing a nut of a screw device according to a first embodiment of the present invention.

FIG. 2 is a perspective view of the nut of FIG. 1 (in which (A) is a perspective view of the nut in a state that the ball circulation groove appears, and (B) is a perspective view of the nut in a state that the loaded ball rolling groove appears.

FIG. 3 is a view showing a state in which the nut is incorporated with a screw shaft.

FIG. 4 is a view showing a ball passing area of the loaded ball rolling groove (in which (A) shows a state viewed from an axial direction of the screw shaft and (B) shows a state viewed from a side of the screw shaft).

FIG. 5 is a developed view in which the loaded ball rolling groove and the ball circulation groove (return portion) formed to an inner peripheral surface (cylindrical surface) of the nut are developed in plane.

FIG. 6 is a view of moving loci of the ball and center of ball at the time of rotating the screw shaft.

FIG. 7 is a developed view of the locus of the center of the ball.

FIG. 8 is a view showing one example of a cutting device for cutting the inner peripheral surface of the nut.

FIG. 9 is a view showing a groove to be formed to the nut.

FIG. 10 is a view of one example showing a state in which the inner peripheral surface of the nut is cut by means of bite.

FIG. 11 is a view showing a screw device according to a second embodiment of the present invention.

FIG. 12 is a view showing a nut of a screw device according to a third embodiment of the present invention (in which (A) shows a state that the nut is formed with a hole, (B) shows a state that a foreign material is fitted in the nut, and (C) shows a state that a groove is cut-formed to the nut).

FIG. 13 is a view showing a nut of a screw device according to a fourth embodiment of the present invention (in which (A) shows a state in which a portion of the nut is cut away to easily show a groove of one turn and (B) shows a perspective view of the nut).

FIG. 14 is a view showing a nut of a screw device according to a fifth embodiment of the present invention (in which (A) shows a perspective view and (B) shows a perspective view of the nut cut into two sections).

### REFERENCE NUMERAL

1, 22, 31—nut, 2, 25—loaded ball rolling groove, 3, 24, 33—ball circulation groove, 6—ball rolling groove, 13—cutting tool (end mill), 19—crowing, 21—ring, 26—foreign material.

### BEST MODE FOR EMBODYING THE INVENTION

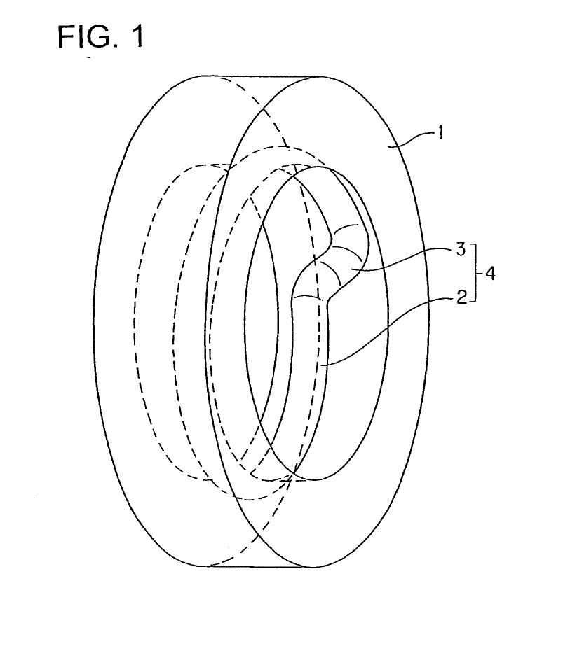

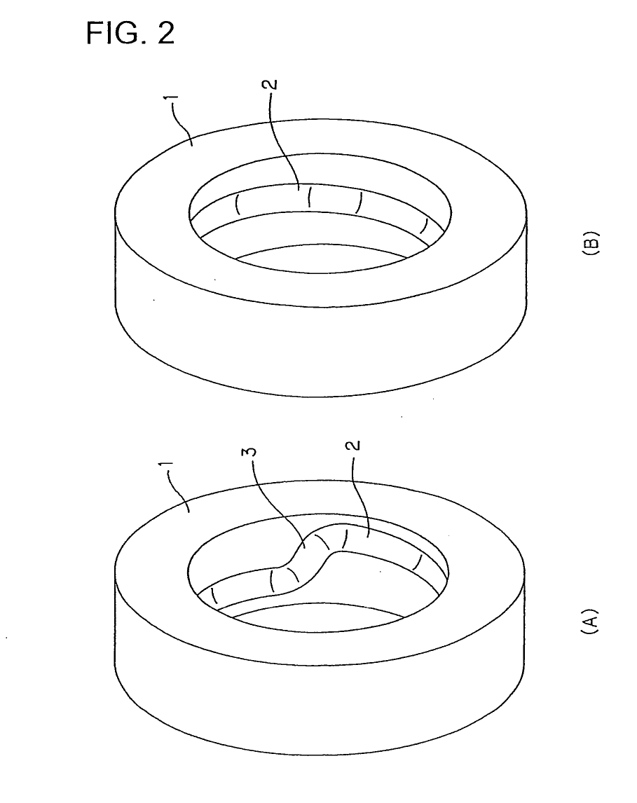

FIG. 1 shows a nut 1 of a screw device according to the first embodiment of the present invention. The nut 1 of this embodiment is composed of a single ring. A loaded ball rolling groove 2 is formed in an inner peripheral surface of the nut 1 as a loaded rolling member rolling groove having spiral shape of less than one-turn. The loaded ball rolling groove 2 has a lead coincident with a ball rolling groove of a screw shaft, mentioned hereinlater. The ball circulation groove 3 as a rolling member circulation groove connects one and the other ends of the loaded ball rolling groove 2 and has a lead of a direction reverse to that of the loaded ball rolling groove. These loaded ball rolling groove 2 and the ball circulation groove 3 constitutes a one-turn of groove 4. No groove is formed in the inner peripheral surface of the nut 1 other than one-turn of the groove 4, and the inner peripheral surface of the nut 1 constitutes a cylindrical surface. In FIG. 2, (A) shows a perspective view of the nut 1 in which the ball circulation groove 3 appears, and (B) shows a perspective view of the nut 1 in which the loaded ball rolling groove 2 appears.

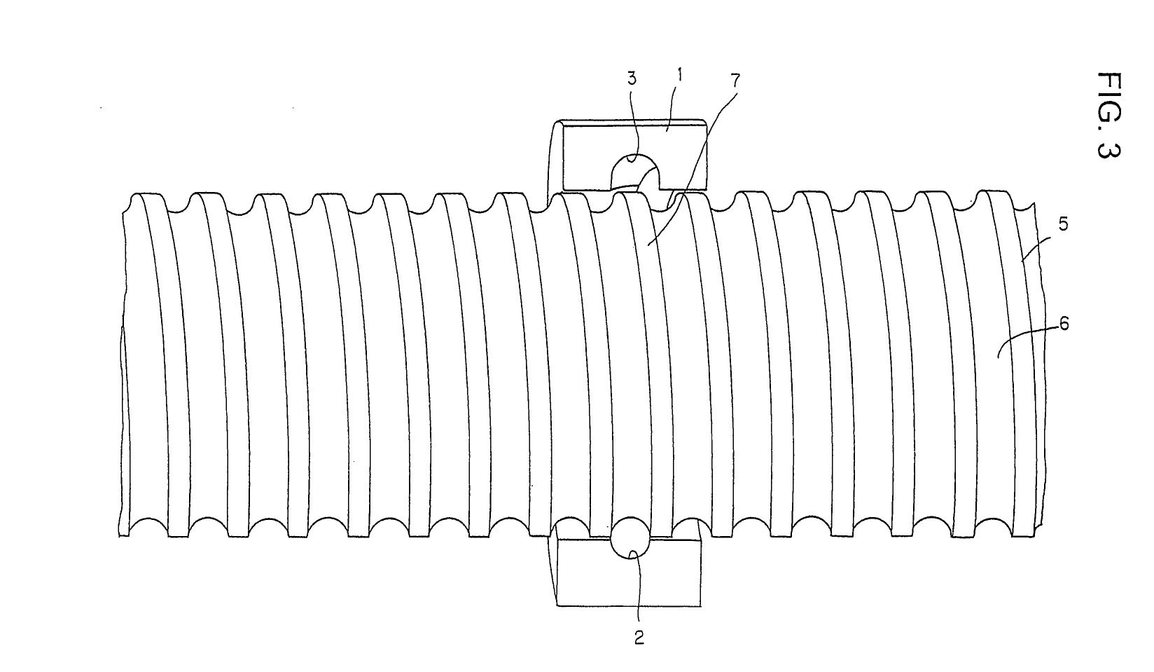

FIG. 3 shows the nut 1 incorporated in the screw shaft. A ball rolling groove 6 is formed as rolling member rolling groove in form of spiral having a predetermined lead on an outer peripheral surface of the screw shaft 5. The loaded ball rolling groove of the nut 1 opposes to the ball rolling groove 6 of the screw shaft 5. A plurality of balls, not shown, as a plurality of rolling members, which can roll and move, are arranged and incorporated between the loaded ball rolling groove 2 and the ball circulation groove 3 of the nut 1 and the ball rolling groove 6 of the screw shaft 5. A spacer is disposed between the adjacent balls to prevent the contacting to each other. These spacers may be retained in a series form with a flexible belt-shaped member. According to the relative rotation of the nut to the screw shaft 5, a plurality of balls roll under load between the loaded ball rolling groove 2 of the nut 1 and the ball rolling groove 6 of the screw shaft 5.

The ball circulation groove 3 of the nut 1 corresponds to the deflector of a conventional structure. The ball circulation groove 3 serves such that the ball can get over the screw thread 7 of the screw shaft 5 so that the ball rolling on the loaded ball rolling groove 2 of the screw shaft 5 circulates around the screw shaft 5 and returns to the loaded ball rolling groove 2.

The groove shapes of the loaded ball rolling groove 2 and the ball circulation groove 3 of the nut 1 will be described hereunder.

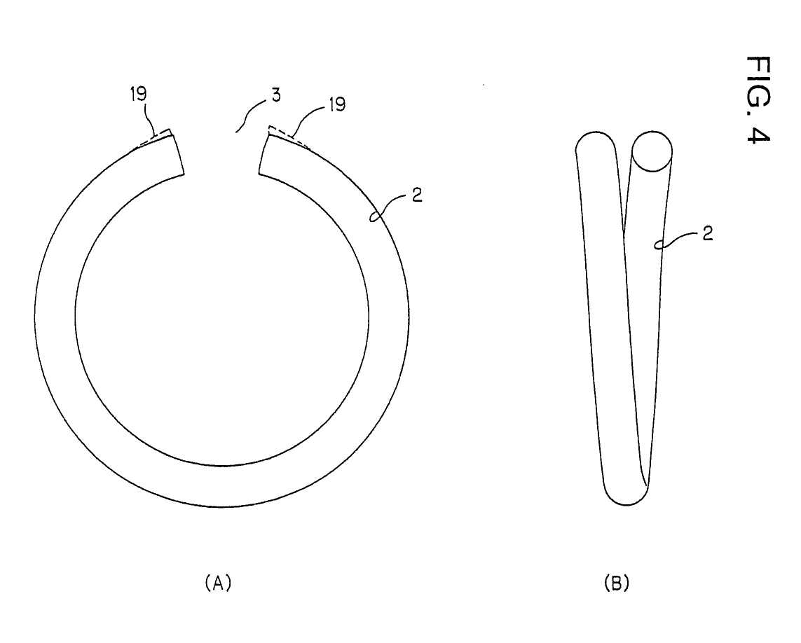

The loaded ball rolling groove 2 forming a locus of the ball to be loaded is formed, as like as a groove shape of a general ball screw nut, so that the ball moves in the axial direction of the screw shaft 5 at a constant rate in accordance with a rotation angle of the screw shaft with respect to the axis. FIG. 4 shows a ball passing area of the loaded ball rolling groove 2 at a time when the screw shaft is virtually rotated by 360 degrees of angle around the axis, in which (A) shows the ball passing area of the loaded ball rolling groove 2 as viewed from the axial direction of the screw shaft, and (B) shows the ball passing area as viewed from the side of the screw shaft.

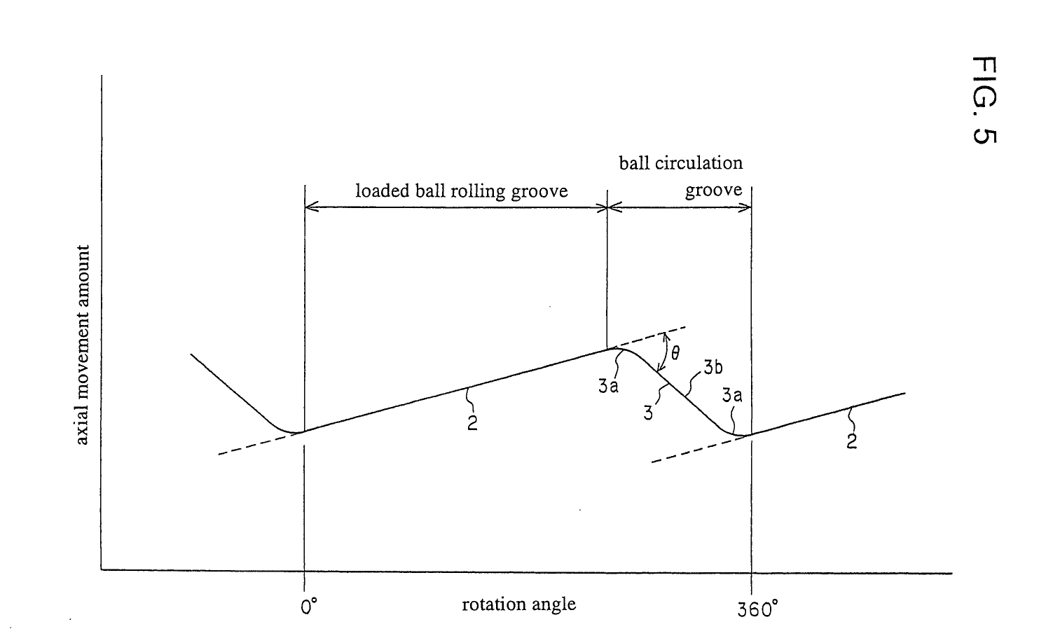

FIG. 5 is a view developing in a plane the loaded ball rolling groove 2 and the ball circulation groove 3 (return portion) formed to the inner peripheral surface (cylindrical surface) of the nut. The locus of the center of the ball moving on the loaded ball rolling groove 2 constitutes a straight line in a plane. The locus of the center of the ball moving on the ball circulation groove 3 constitutes a curved line, in a plane, continuously connecting a pair of parallel lines. In FIG. 5, this curved line is shown with a circular-arc 3a and a straight line 3b. For this curved line, many curved lines other than this curved line may be utilized. The ball rolling on the loaded ball rolling groove 2 passes the ball circulation groove 3 and then return to the loaded ball rolling groove 2.

The loaded ball rolling groove 2 is formed, for example, to a portion having 330 degrees of angle within 360 degrees of angle of one round of the inner peripheral surface of the nut 1, and on the other hand, the ball circulation groove 3 is formed, for example, to a portion having 30 degrees of angle thereon. This is because the loaded ball rolling area makes large to increase a load capacity. In order not to rapidly change the advancing direction of the ball moving on the loaded ball rolling groove 2 in the ball circulation groove, an inclination angle θ of the line of the ball circulating groove 3 with respect to the line in the loaded ball rolling groove 2 is set to be less than 60 degrees of angle, for example.

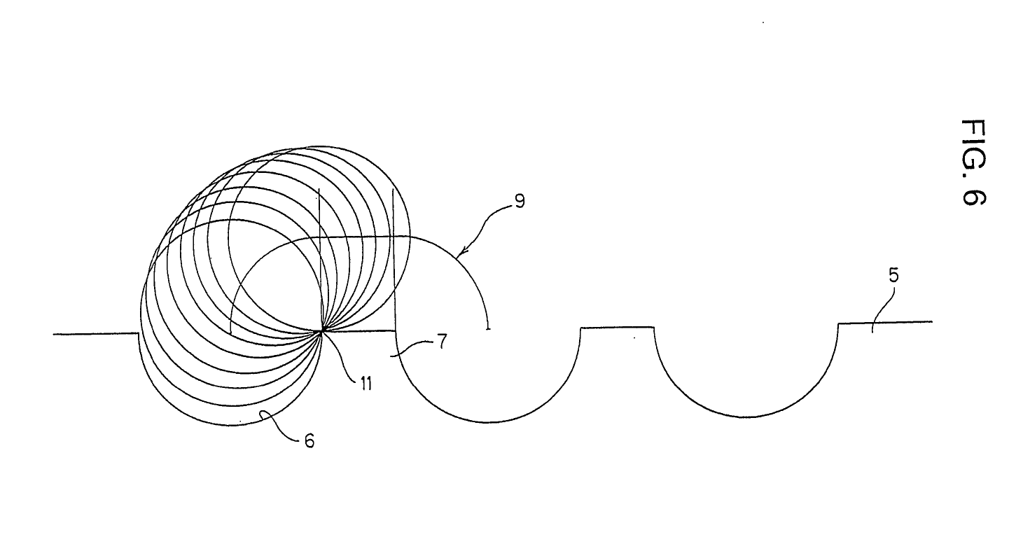

In the ball circulation groove 3, the ball jumps up the thread 7 of the screw shaft 5, so that the ball can move in the radial direction of the screw shaft 5. FIG. 6 shows a moving locus of the ball and the ball center at the time of rotating the screw shaft 5. In FIG. 6, the ball on the ball rolling groove 6 rises at a corner 11 of the thread 7 of the screw shaft 5 as being advanced. In this moment, the ball rises up while being supported at a portion between the corner 11 of the thread 7 and the ball circulation groove 3 of the nut 1, and the locus 9 of the center of the ball describes a circular-arc around the corner of the thread 7. In a case where the corner 11 of the screw thread 7 is rounded or chamfered, the locus of the center of the ball describes a shape coincident with the rounded or chamfered shape, which is substantially the same as the circular-arc. Herein, if the inner diameter of the nut 1 is made smaller than the diameter of the locus of the center of the ball rolling on the ball rolling groove 6 as viewed from the axial direction of the screw shaft 5, the ball would be easily scooped.

The moving locus of the ball is described hereinabove, moving loci of other members, such as spacers, running in association with the balls is considered to be substantially the same as the moving locus of the ball.

Three-dimensional shape of the ball circulation groove 3 of the nut is defined as an envelop (enveloping surface) of an aggregation of the sectional shapes of the ball circulation groove 3 in a plane perpendicular to a surface formed by contact lines of the ball center locus 9 on dividing points at which the ball center locus 9 of the ball circulation groove 3 shown in FIGS. 5 and 6 are divided at equal interval with a length along the curved line and perpendicular lines descending from the respective dividing points to the axis of the screw shaft 5.

As an exemplary embodiment, the sectional shape of the ball circulation groove 3 was made so as to have a circular-arc shape having a radius slightly larger than a radius of the ball, and a plane was rotated by an inclination of the developed view of the ball center locus 9 shown in FIG. 7 in the tangential direction. In this manner, the ball circulation groove 3 was described.

If the described ball circulation groove 3 and the loaded ball rolling groove 2 can be worked precisely, the ball can be moved with substantially no play, and the ball can be smoothly circulated. The working method of the ball circulation groove 3 and the loaded ball rolling groove will be described hereunder.

First, the nut 1 having a cylindrical shape is subjected to heat treatment of quenching or tempering. In this state, the inner peripheral surface of the nut 1 maintains its cylindrical surface shape and any loaded ball rolling groove 2 and ball circulation groove are not formed. Next, the inner peripheral surface of the nut 1 which was preliminarily heat-treated is cut to thereby form the loaded ball rolling groove 2 and the ball circulation groove 3. In this working, since the loaded ball rolling groove 2 and the ball circulation groove 3 are formed at the same time with same cutting step by the same cutting tool, the loaded ball rolling groove 2 and the ball circulation groove 3 can be precisely worked to the nut 1. Since the cutting step is performed after the heat treatment, the influence of the distortion due to the heat treatment can be eliminated. In addition, if the cutting is performed after the heat treatment, surface roughness of the loaded ball rolling groove 2 and the ball circulation groove 3 can be improved.

In this embodiment, only the loaded ball rolling groove 2 of the nut 1 is ground by a grinding stone, for example, after the cutting working, and the ball circulation groove 3 is not ground. On the loaded ball rolling groove 2, the ball rolls with the load being applied, it is desired for the groove 2 to be finely worked in the grinding working. On the other hand, since the ball rolls on the ball circulation groove 3 with the load being not applied, and in addition, the groove 3 has a complicated shape, it is advantageous for the groove 3 not to be ground in term of cost.

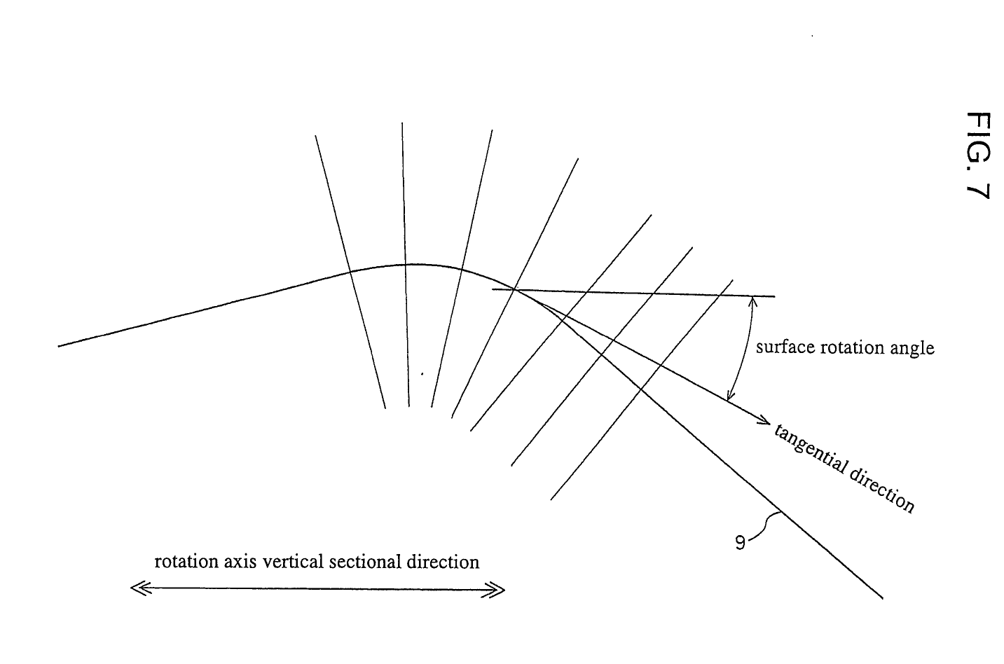

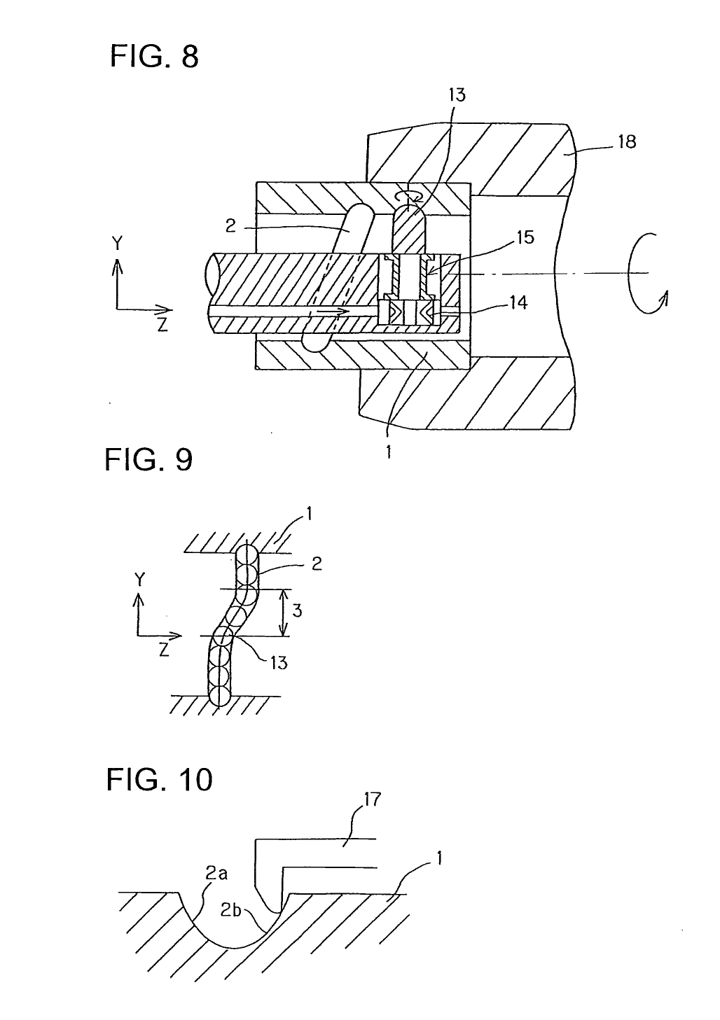

FIG. 8 shows one example of a cutting device for cutting the inner peripheral surface of the nut 1. This cutting device gives a rotational cutting main motion to an end mill 13 as a cutting tool disposed inside the nut 1 and also gives a feeding motion to the nut 1 and the end mill 13. More specifically, the cutting device is operated in a manner such that the end mill 13 moves, as the feeding motion, to the axis (Z-axis) direction of the nut 1 while the nut 1 being rotating around the axis of the nut gripped by a chuck 18. The position of the end mill 13 in the radial (Y-axis) direction of the nut is adjusted so as to control cutting depth to the nut 1 in the radial direction thereof by means of the end mill 13.

A highly pressurized fluid is struck to a turbine 14, The end mill 13 rotatably supported by a dynamic pressure bearing 15 is rotated at, for example, 2 to 4000 rpm to thereby cut in a groove to the inner peripheral surface of the nut 1. The rotation of the nut 1 around its axis and the movement of the end mill 13 in the z-axis and y-axis directions are synchronized with each other in conformity with the lead angle of the loaded ball rolling groove 2 and the shape of the ball circulation groove 3, and as shown in FIG. 9, these grooves are worked continuously. Since the loaded ball rolling groove 2 and the ball circulation groove 3 can be worked by the end mill 13 rotating at a high speed, the lead and the depth can be adjusted regardless of the rotation of the nut 1. Because of this reason, it becomes possible to work a screw of large lead, and a free curved line can be selected as the ball circulation groove shape. As a tool, if a grinding stone is utilized in place of the end mill 13, the groove may be ground.

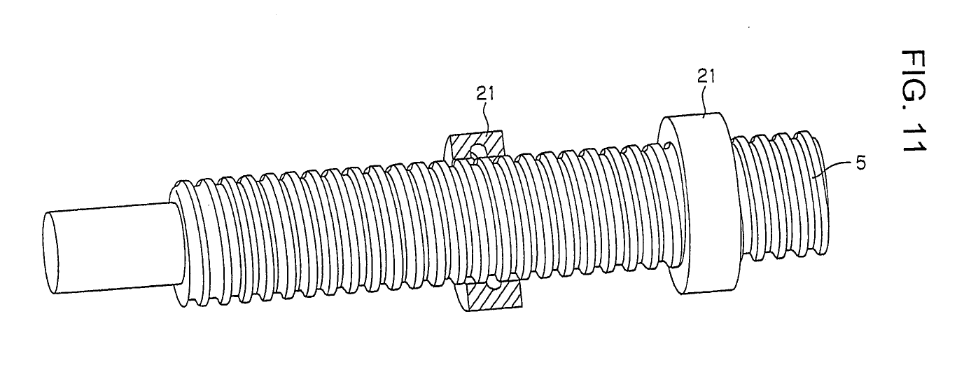

Other than the above, it is possible to manufacture the grooves by an inner diameter grooving working called conventionally as “inner cam”. FIG. 10 shows this method (an example of cutting an inner peripheral surface of the nut by means of bite). In this example, the groove is cut and worked at its lateral inclining surfaces 2a, 2b by the bite while the nut 1 being rotated about the axis. In the case of the nut having a constant lead, the groove may be cut by using a forming tool. However, for the loaded ball rolling groove 2 and the ball circulation groove 3, the leads are inclined in substantially reverse directions. The loaded ball rolling groove 2 and the ball circulation groove 3 having reversely inclining leads are cut by using a fixed forming tool, the formed grooves do not provide constant groove widths. Because of this reason, there is adopted a method in which one of the inclined lateral surfaces 2a of the groove is cut by the bite 17 while rotating the nut 1 in one direction, and thereafter, the other inclined surface 2b of the groove is cut by the bite 17 while rotating the nut in the reverse direction.

The circulation of the ball will be explained hereunder. In the loaded ball rolling groove 2 of the nut 1, the ball rolls, in a snapped state, between the loaded ball rolling groove 2 of the nut 1 and the ball rolling groove 6 of the screw shaft 5. The ball given with a force for moving in the advancing direction in the loaded ball rolling groove 2 is not given with a force for moving in the advancing direction in the ball circulation groove 3, so that it becomes necessary to push inside the ball in the ball circulation groove 3 by the ball in the loaded ball rolling groove 2. The balls in the ball circulation groove 3 alternately include a ball pushed against the nut side and a ball pushed against the screw shaft side, and in the ball circulation groove 3, the balls advance in a meandering manner. At the time when the balls advancing in the meandering manner in the ball circulation groove 3 enter the loaded ball rolling groove 2, in order to reduce resistance n the ball advancing direction, a crowing 19 is formed at a connecting portion of the loaded ball rolling groove 2 connected to the ball circulation groove 3 as shown in FIG. 4 so as to gradually widen, toward the ball circulation groove 3, a gap between the ball rolling groove 6 of the screw shaft 5 and the loaded ball rolling groove 2 of the nut 1.

Next, the ball insertion method will be explained. The ball is inserted between the loaded ball rolling groove 2 and the ball circulation groove 3 of the nut 1 and the ball rolling groove 6 of the screw shaft 5 in a state that the nut 1 is shifted near the end of the screw shaft 5. Since the loaded ball rolling groove 2 and the ball circulation groove 3 of the nut 1 are formed in one turn, it is prevented the ball from entering an extra portion as in a conventional deflector-type ball screw, thus making easy the ball insertion working. In addition, when the loaded ball rolling groove 2 and the ball circulation groove 3 are integrally cut out, the lengths thereof in the circumferential directions can be made constant, so that there cause any no inconvenience at a time of interposing the spacer between the adjacent balls.

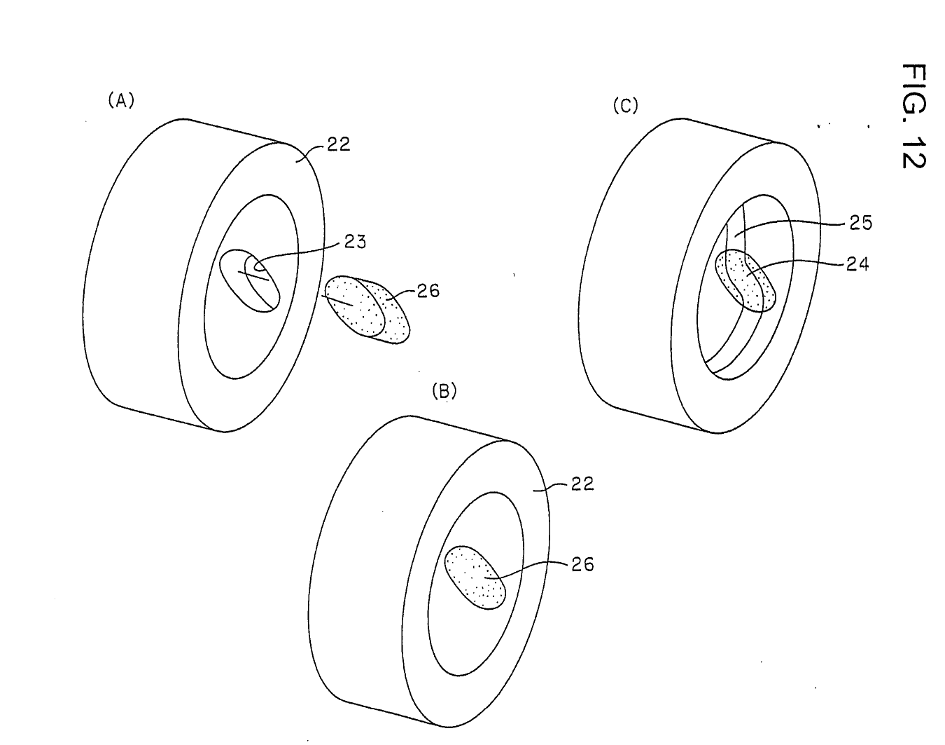

FIG. 11 shows a screw device according to the second embodiment of the present invention. In this exemplary embodiment, a plurality of, two, for example, rings 21 in which one-turn of groove is formed are mounted to one screw shaft 5. A spacer, not shown, is disposed between these two rings 21, and two rings 21 are mounted to both ends of the spacer like a bearing unit These spacer and two rings 21 constitute a nut. By adjusting a dimension of the spacer, a preload can be regulated and moment addition capacity of the nut can be appropriately set Such nut may be preferably utilized for an electric power steering device in which an output of an electric motor is transmitted to a steering shaft as propelling force through a ball screw.

Further, one-turn groove of the ring 21 in this second embodiment may be formed as like as the nut in the first embodiment by performing the cutting working or, different from the first embodiment, may be formed by a bulging formation from a pipe material, an assembling method of a powder sintering and groove burnishing, or an injection molding of a resin material.

FIG. 12 shows a screw device according to the third embodiment of the present invention, in which (A) shows a state in which a hole 23 is formed to a portion corresponding to a ball circulation groove 24 of a nut 22, (B) shows a state in which a foreign material 26 is fitted in the nut 26, and (C) shows a state in which a loaded ball rolling groove 25 and the ball circulation groove 24 are formed to the nut through the cutting working. As shown in (A), the hole 23 is first formed to the portion corresponding to the ball circulation groove 24 of the nut 22. Next, as shown in (B), the foreign material 26 is pressed into the hole 23, and as such foreign material 26, is utilized a material having attenuating performance, lubricating property and sound absorbing ability. Then, as shown in (C), the nut 22 with the foreign material 26 being fitted is subjected to the cutting working so as to form the loaded ball rolling groove 25 and the ball circulation groove 24. The combination of the nut 22 with the foreign material 26 can impart the attenuating effect, lubricating effect, sound absorbing effect or damping effect to the nut 22.

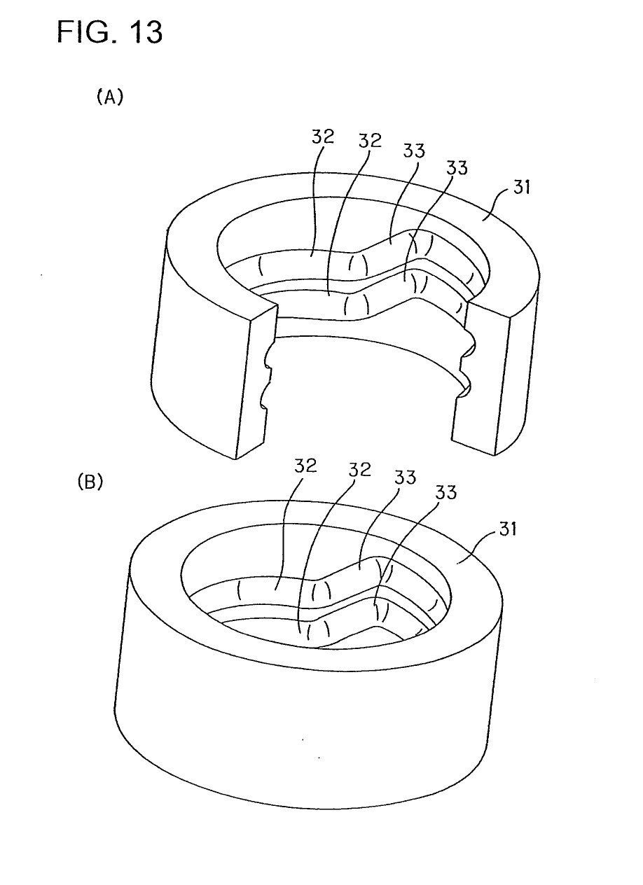

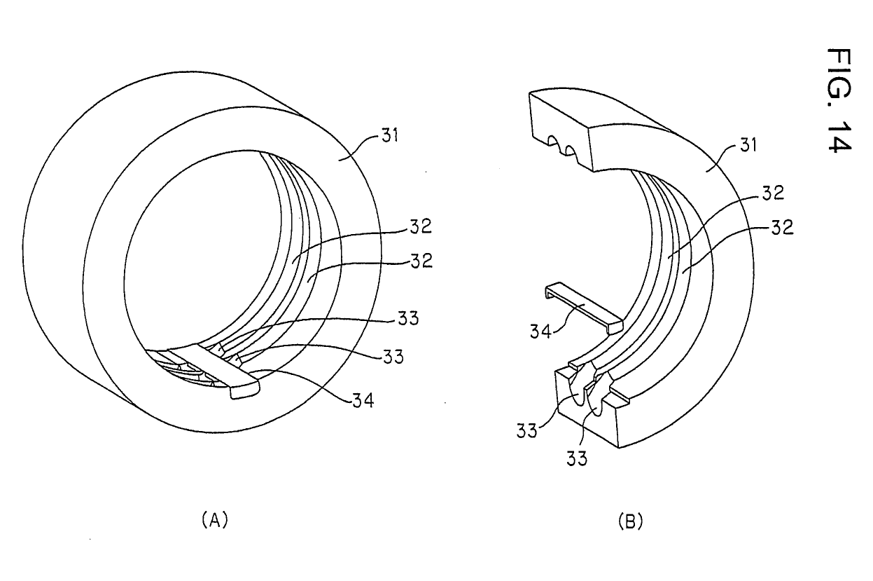

FIG. 13 shows a nut 31 of a screw device according to the fourth embodiment of the present invention. In this exemplary embodiment, two one-turn of grooves 32 are formed in an inner peripheral surface of the nut 31. In FIG. 13, (A) shows a state in which a portion of the nut is cut away for easy understanding of the one-turn of groove 32, and (B) shows a perspective view of the nut. The groove shape of the one of two one-turn of grooves 32 is the same as single one-turn of groove. In this embodiment, phases of the ball circulation grooves 33 of the two one-turn of grooves are coincident at the circumferential same position. By adopting this arrangement, the entire length of the nut 31 can be shortened, and there can provided a structure strengthened against a moment from the inclination of the axis of the ball screw 5 and the center line of the nut 31.

FIG. 14 shows a nut of a screw device according to the fifth embodiment of the present invention. In FIG. 14, (A) shows a perspective view, and (B) shows a perspective view of a nut cut into two sections. In this exemplary embodiment, two one-turn of grooves are formed in the inner peripheral surface of the nut 31, and a lid 34 is formed to the ball circulation groove 33 of the nut by using an independent member. That is, it functions as like as so-called a tunnel-type deflector, and when the ball circulating by one-turn gets over the thread 7 of the screw shaft (FIG. 3), the ball is prevented from contacting to the thread 7 of the screw shaft 5. It will be expected to achieve an effect of preventing friction and generation of noise in a case of using a forged screw shaft.

For an application to a multi-thread screw, the application would be done by providing plural pairs of loaded ball rolling grooves and the ball circulation grooves during one-turn circulation of the rolling member around the screw shaft. It is also applicable by jumping over the screw thread by means of lid of the fifth embodiment.

1. A screw device comprising:
a screw shaft formed, on an outer peripheral surface thereof, with a rolling member rolling groove in form of spiral;
a nut formed, on an inner peripheral surface thereof, with at least single one-turn of groove constituted by a loaded rolling member rolling groove having a partial circle less than one circle of groove and corresponding to the rolling member rolling groove of the screw shaft and a rolling member circulation groove connecting one and another ends of the loaded rolling member rolling groove; and
a plurality of rolling members arranged and accommodated between the rolling member rolling groove of the screw shaft and the loaded rolling member rolling groove and the rolling member circulation groove of the nut,
wherein the loaded rolling member rolling groove and the rolling member circulation groove of the nut are formed in the inner peripheral surface thereof by preliminarily performing a heat-treatment to a cylindrical surface of the nut on which the loaded rolling member rolling groove and the rolling member circulation groove has not yet formed, and thereafter, by performing a cutting working to the inner peripheral surface of the nut having the heat-treated cylindrical surface.

2. The screw device according to claim 1, wherein only the loaded rolling member rolling groove of the nut is ground after the cutting working, and the rolling member circulation groove of the nut is only subjected to the cutting working

3. The screw device according to claim 1 or 2, wherein the nut is composed of a plurality of rings, assembled in an axial direction of the screw shaft, each of which has an inner peripheral surface on which at least one-turn of groove constituted by a loaded rolling member rolling groove having a partial circle less than one circle of groove and corresponding to the rolling member rolling groove of the screw shaft and a rolling member circulation groove connecting one and another ends of the loaded rolling member rolling groove.

4. The screw device according to claim 1 or 2, wherein a crowning is formed at a connecting portion of the loaded rolling member rolling groove to the rolling member circulation groove so that a gap between the rolling member rolling groove of the screw shaft and the loaded rolling member rolling groove is gradually widened toward the rolling member circulation groove.

5. The screw device according to claim 1 or 2, wherein a foreign material different in substance from that of the nut is fitted to the rolling member circulation groove of the nut, and the loaded rolling member rolling groove of the nut and the rolling member circulation groove of the foreign material are formed by preliminarily cutting the nut to which the foreign material is fitted.

6. A method of manufacturing a screw device in which a rolling member is interposed between a screw shaft and a nut, the method comprising:
a step for preliminarily performing a heat treatment to the nut having an inner peripheral surface as a cylindrical surface; and
forming at least one-turn of groove constituted by a loaded rolling member rolling groove having a partial circle less than one circle of groove and corresponding to the rolling member rolling groove of the screw shaft and a rolling member circulation groove connecting one and another ends of the loaded rolling member rolling groove by cutting and working the heat-treated inner peripheral surface of the nut.

7. The screw device manufacturing method according to claim 6, wherein the one-turn of groove is subjected to the cutting working by imparting a rotational cutting main motion to a cutting tool disposed inside the nut and imparting a feeding motion to at least one of the nut and the cutting tool.

8. The manufacturing method of the screw device according to claim 7, wherein the nut is freely rotated around the axis of the nut, the cutting tool is an end mill which performs rotational movement around the axis in the radial direction of the nut and is adjustable in position in the axial and radial directions of the nut, and the rotation around the axis of the nut and the movement of the end mill in the axial and radial directions of the nut are synchronized in conformity with shapes of the loaded rolling member rolling groove and the rolling member circulation groove to thereby continuously work the loaded rolling member rolling groove and the rolling member circulation grooves.
